(19) United States
(12) Patent Application Publication
(10) Pub. No.: US 2010/0161238 A1
(43) Pub. Date: Jun. 24, 2010

(54) Method and System for Detecting Peptide Peaks in HPLC-MS Signals

(75) Inventors: Salvatore Cappadona, Confienza (IT); Linda Pattini, Milano (IT); Sergio Cerutti, Milano (IT); Peter James, Lund (SE); Fredrik Levander, Lund (SE)

Correspondence Address: KING & SPALDING, 1185 AVENUE OF THE AMERICAS, NEW YORK, NY, 10036-4003, US

(73) Assignee: Politecnico di Milano, Milano (IT)

(21) Appl. No.: 12/602,319

(22) PCT Filed: May 30, 2008
(86) PCT No.: PCT/IT2008/000360

§ 371 Date: Mar. 2, 2010

(30) Foreign Application Priority Data
May 31, 2007 (IT) MI2007A001107

(51) Int. Cl. G01N 30/86; H01J 49/26; G06F 19/00

(52) U.S. Cl. 702/19; 250/282; 73/61.52

(57) ABSTRACT

The present invention relates to a method, a computer tool and a system for detecting peptide peaks in measurement signals (11) generated by HPLC-MS instruments. The method comprises the steps of: providing an intensity column vector (SIC) representative of the elution values at a specific mass value (m/z) of the measurement signal (11); cam. performing a wavelet decomposition (15) of such values of said intensity column vector (SIC) to generate a first processed vector (16) representative of the smoothed intensity values of the intensity column vector (SIC); providing a threshold value (S) and performing a wavelet decomposition (17) as a function of the value of said threshold (S) to generate the second processed vector (18) representative of said intensity column vector (SIC) cleaned of any oscillations generated by stochastic noise (e(t)); processing said first processed vector (16) and said second processed vector (18) to generate a third processed vector (19) identifying the baseline values of said intensity column vector (SIC); processing said intensity column vector (SIC) and said second (18) and third (19) vectors to generate e filtered vector (20) identifying any peak value (ZJ) below the background noise (12).

The present invention relates to a method, a computer tool and a system for detecting peptide peaks in measurement signals generated by HPLC-MS (High Performance Liquid Chromatography—Mass Spectrometry) instruments, as defined in the preamble of claims 1, 13 and 14 respectively.

More particularly, the invention concerns the detection of peptide peaks, which are combined with a background noise typical of the measurement signals generated by HPLC-MS instruments.

As used herein, the term proteomics is intended to designate the study of the proteome, i.e. the time- and cell-specific complement of the genome.

As is known in the field of proteomics, one of the common methods for analysis of biological tissues and fluids consists in the combination of two instruments, i.e. a HPLC (High Performance Liquid Chromatography) chromatograph and a Mass Spectrometer MS.

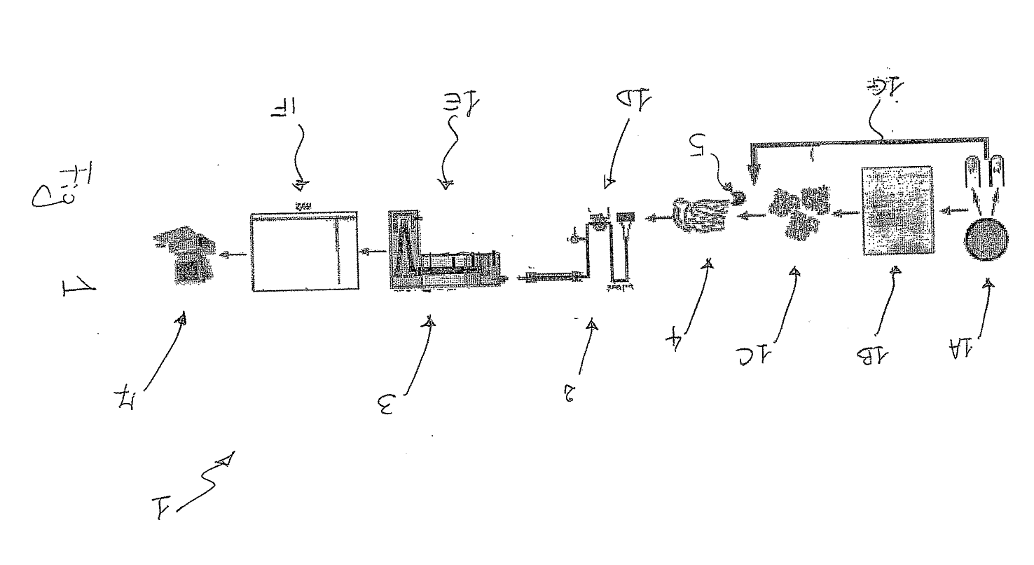

Referring to FIG. 1, which shows a typical acquisition and filtering chain 1 for a proteomic analysis based on the combination of a chromatograph 2 and a spectrometer 3 using, for example, the ESI (ElectroSpray Ionization) technology as a ionization method, it can be seen that, once a sample 1A has been prepared, a step 1B follows in which the protein is separated by 2D-page.

This is followed by a step 1C of excision of single protein spots from the 2D gel and a step 4 in which the protein is digested by a proteolytic enzyme 5, typically trypsin.

Otherwise, as shown in FIG. 1, a step may be provided in which the protein extract is directly digested without being first separated by means of gel.

Then, the acquisition and filtering chain 1 provides a first chromatographic separation 1D of the resulting peptides based on their hydrophobicity and a second separation 1E of such peptides based on their mass.

Particularly, the chromatographic separation step 1D is carried out using the HPLC chromatograph 2 and the second separation step 1E is carried out using the mass spectrometer MS 3.

Finally, the acquisition and filtering chain 1 provides a step 1F for identification of the biological sample proteins from the detected peptides, with a bottom-up approach known as PMF (Peptide Mass Fingerprinting) 7, as is known to those of ordinary, skill in the art.

Nonetheless, the combination of the HPLC chromatograph 2 and the MS spectrometer 3 introduces chemical noise peaks in mass spectra, which are morphologically undistinguishable from peptide peaks and are of such an intensity as to wholly hide low concentration peptides.

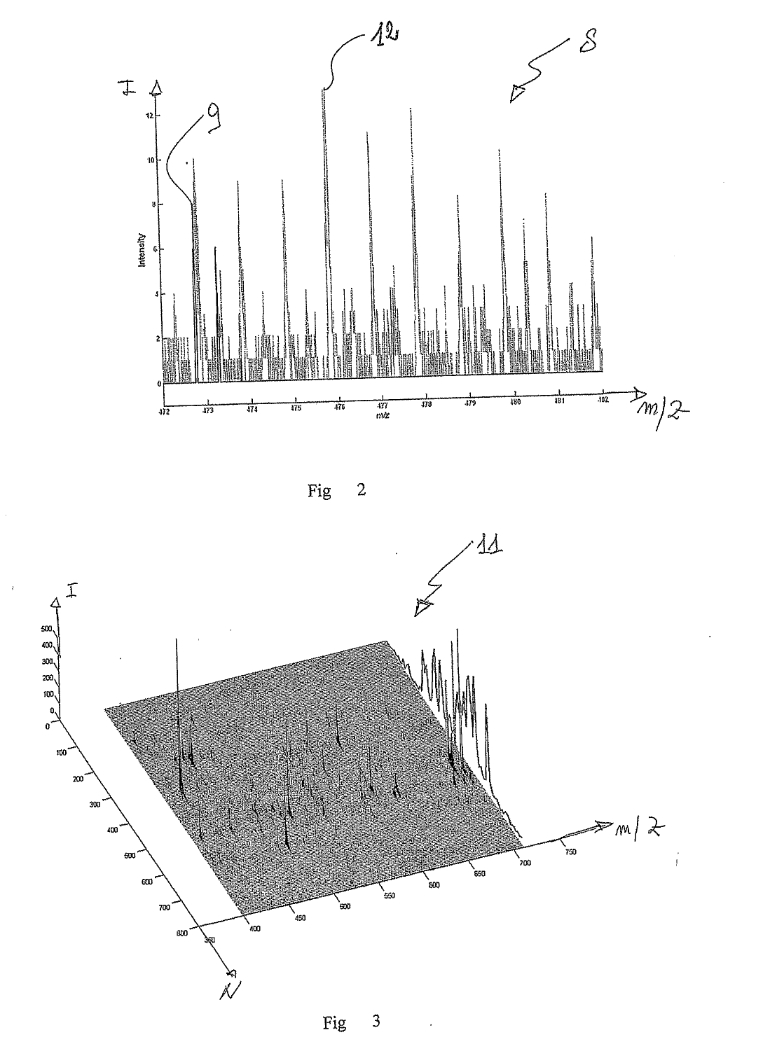

Such a situation is, for example, shown in FIG. 2, wherein it is impossible discriminate in a measure signal 8 (that is a measure signal being part of a single scan) a mass spectrum of the biological sample 1A generated by the acquisition and filtering chain 1, if a peak value 9 (that is the peak value of a single scan) is really a peptide peak or noise 12 (that is background noise, chemical and/or stochastic noise) intrinsic of the measure instruments being part of such acquisition and filtering chain 1.

The causes of this noise are not wholly clear and have not been extensively investigated from a theoretical point of view.

One of the most probable origins seems to lie in the detection step 1E by the mass spectrometer 4, both of the movable phase used for chromatographic peptide separation 1D and of a fraction of ions produced by ESI ionization, which skips the mass analysis process and reaches the detector of the spectrometer at times that are stochastically unrelated to the spectrometer settings.

Nonetheless, regardless of the origin of the introduction of such noise peaks that can hide peptide peaks, little or nothing has been actually proposed heretofore to remove these peaks in the instruments of the acquisition and filtering chain 1.

Even on software level, noise removal approaches have been based on the analysis of the individual scans by the spectrometer 3, which involves the serious drawback of losing an important part of the information, i.e. the chromatographic peptide separation dimension.

In an attempt to obviate the above drawbacks, a number of solutions have been proposed, including those disclosed in the following patents:

WO200438602: this document discloses a method that describes the whole process of acquisition, compression, processing, analysis and visualization of spectroscopically observed chemical and biological compounds. Nevertheless, this method does not involve processing of chromatographic data.

WO200419003: this document discloses a typical use of wavelet decomposition for denoising and compression of individual mass spectra. No reference is made to chromatografic data.

US20030078739: this document discloses a typical approach to peptide peak detection, which is based on clustering of peaks of equal mass in successive scans. The limit of this approach is that chemical noise is also represented by peaks of equal mass in successive scans.

US20030130823: This document discloses the use of wavelet decomposition as a denoising and data compression method.

CA2388842: this document discloses the use of spectrographic data to retrieve chromatographic data. The approach for attenuating background noise from chromatograms is not based on wavelet decomposition.

U.S. Pat. No. 5,885,841: this document discloses a typical use of wavelet decomposition for removing the baseline from chromatographic data (obtained from spectrographic data).The approach described in this document simply consists in chromatographic signal smoothing, and is not significantly more effective than a low-pass filter.

In view of the prior art as described above, the object of the present invention is to improve detection of peptide peaks hidden below the noise threshold in measurement signals which result from the combination of a chromatograph and a spectrometer (HPLC-MS).

According to the present invention, this object is fulfilled by a method for detection of at least one peptide peak value combined with background noise in the data of a measurement signal generated by the combination of a chromatograph and a mass spectrometer, as defined in claim 1.

This object is fulfilled by a computer tool for carrying out the method, which is loaded in the computer memory and run in such computer, as defined in claim 13.

Finally, this object is also fulfilled by a processing system that can create filtered spectrographic files in most common formats such as “.txt”, “mzData”, “mzXML”, etc., as defined in claim 14.

This invention provides a method that can retrieve all Single Ion Chromatograms (SIC) of the experiment and filter the signal in the chromatographic dimension.

Furthermore, the method of the present invention allows identification of morphological differences between chemical noise and peptide peaks.

Also, thanks to the method of the present invention, noise heteroscedasticity can be accounted for, and noise can be filtered according to its intensity in each SIC.

Moreover, the method of the present invention is a post-data processing method that can be implemented with any mass spectrometer MS susceptible of being combined with HPLC chromatography instruments.

It shall be noted that the method allows no on-line implementation on spectrometers, because data processing requires all spectrographic scans to be first acquired and then processed in accordance with the inventive method.

Thus it has to be considered as a post-data processing method.

The characteristics and advantages of the invention will appear more clearly from the following description of a practical embodiment, illustrated by way of a non-limiting example in the annexed drawings, in which:

FIG. 1 is a flow chart of a proteomic analysis process based on the combination of a chromatograph and a spectrometer (HPLC-MS) according to prior art;

FIG. 2 shows a typical measurement signal resulting from the combination of the chromatograph and the spectrometer as shown in FIG. 1 for a single scan by the spectrometer of FIG. 1;

FIG. 3 shows a 3D map resulting from the composition of N scans performed by the acquisition and filtering chain of FIG. 1;

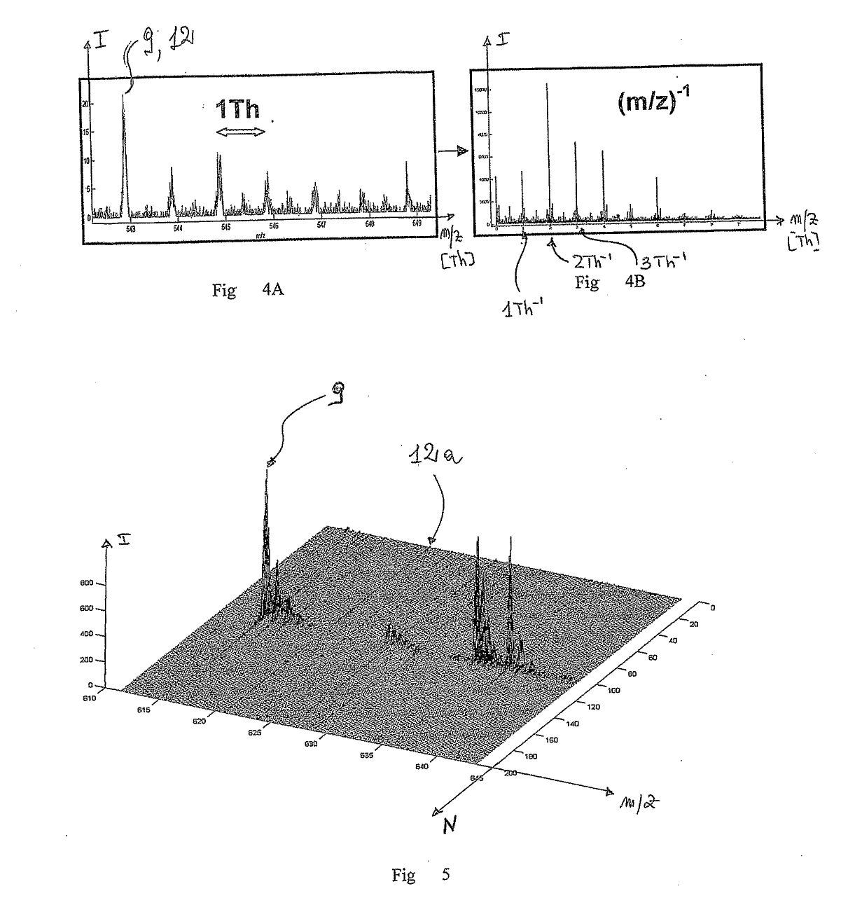

FIGS. 4A and 4B show a diagram that identifies processing of an average spectrum obtained from several successive scans by the acquisition and filtering chain of FIG. 1 and the same diagram transformed by a Fourier transform respectively;

FIG. 5 shows a 3D representation of the chemical noise and the peptide peaks throughout the N scans performed by the acquisition and filtering chain of FIG. 1;

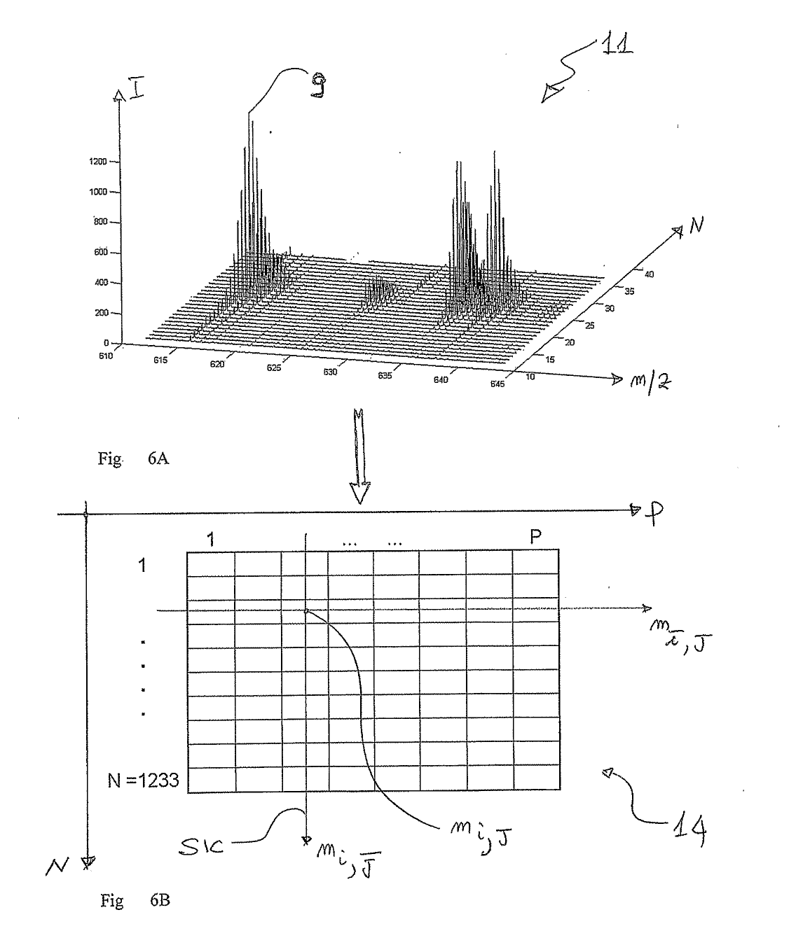

FIGS. 6A and 6B show a step of the method of the present invention, in which a matrix of intensity values is obtained from the individual mass spectra;

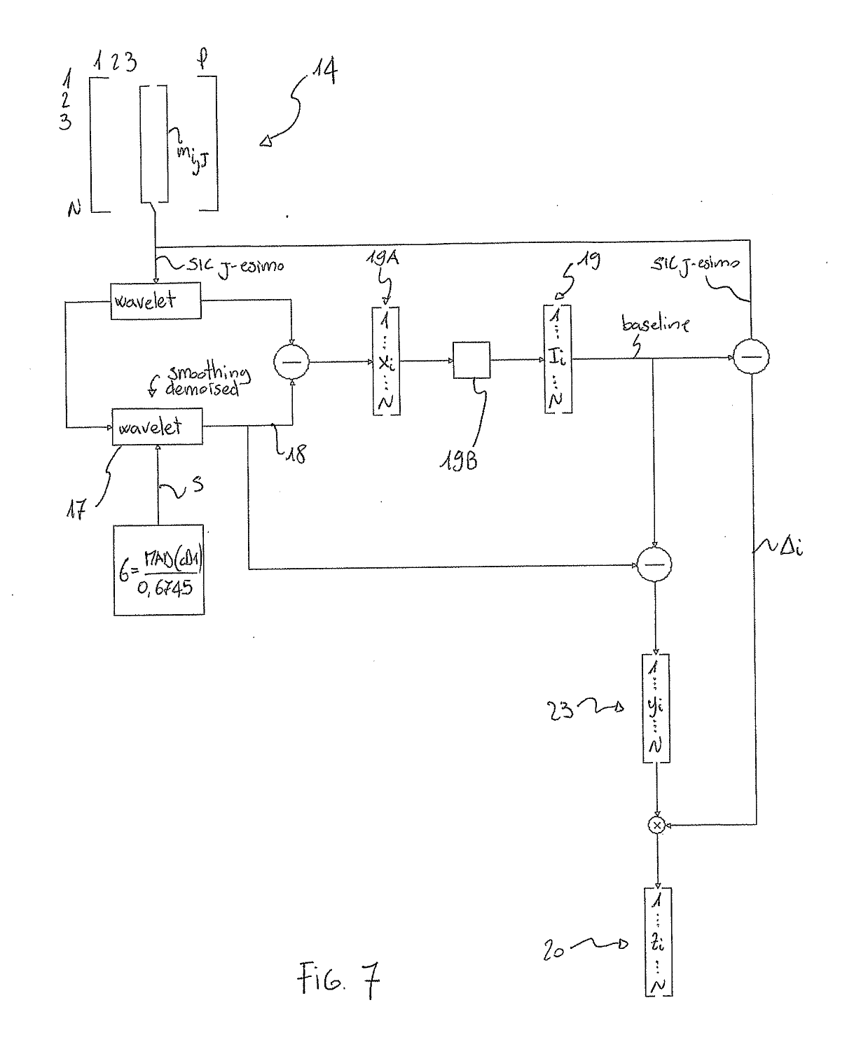

FIG. 7 shows a principle block diagram of the steps of the method of the present invention;

FIGS. 8A and 8B are diagrams in which an approximate level (see FIG. 8A) and a detail level (see FIG. 8B) of the wavelet decomposition are used to represent the baseline and the stochastic noise of the signal generated by the acquisition and filtering chain of FIG. 1;

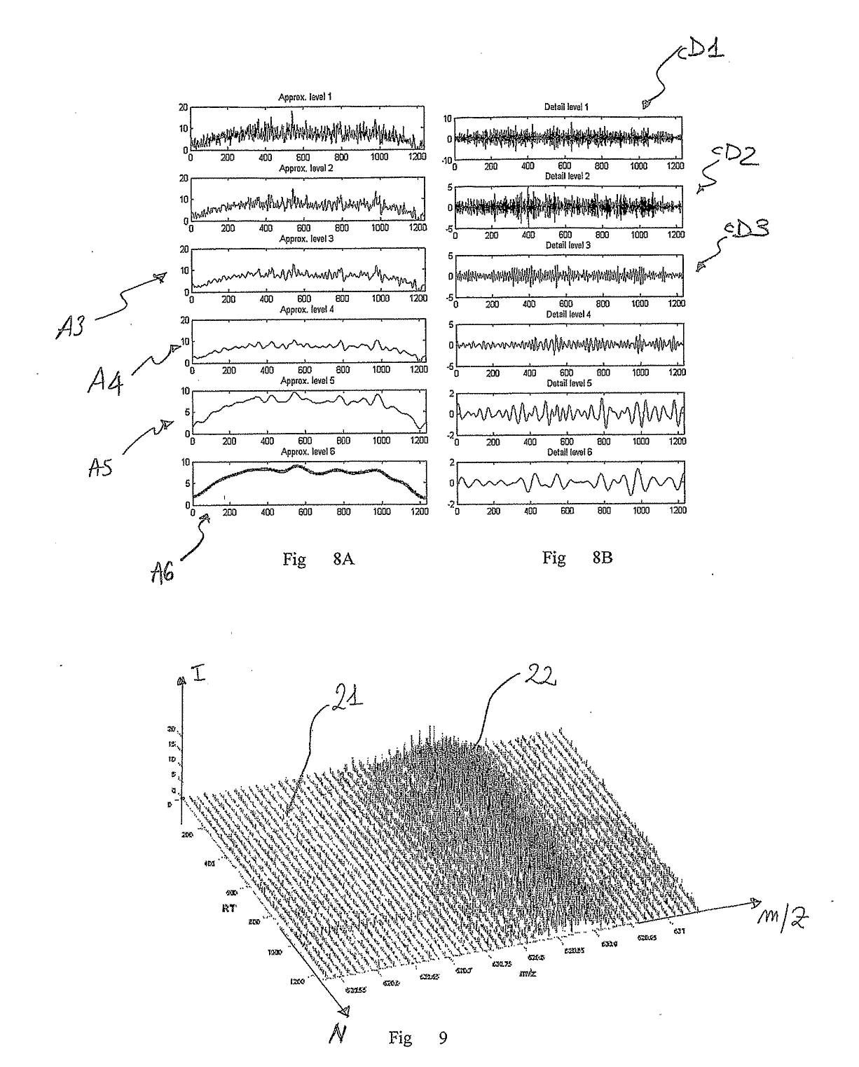

FIG. 9 shows a 3D enlarged map of the signal generated by the acquisition and filtering chain of FIG. 1;

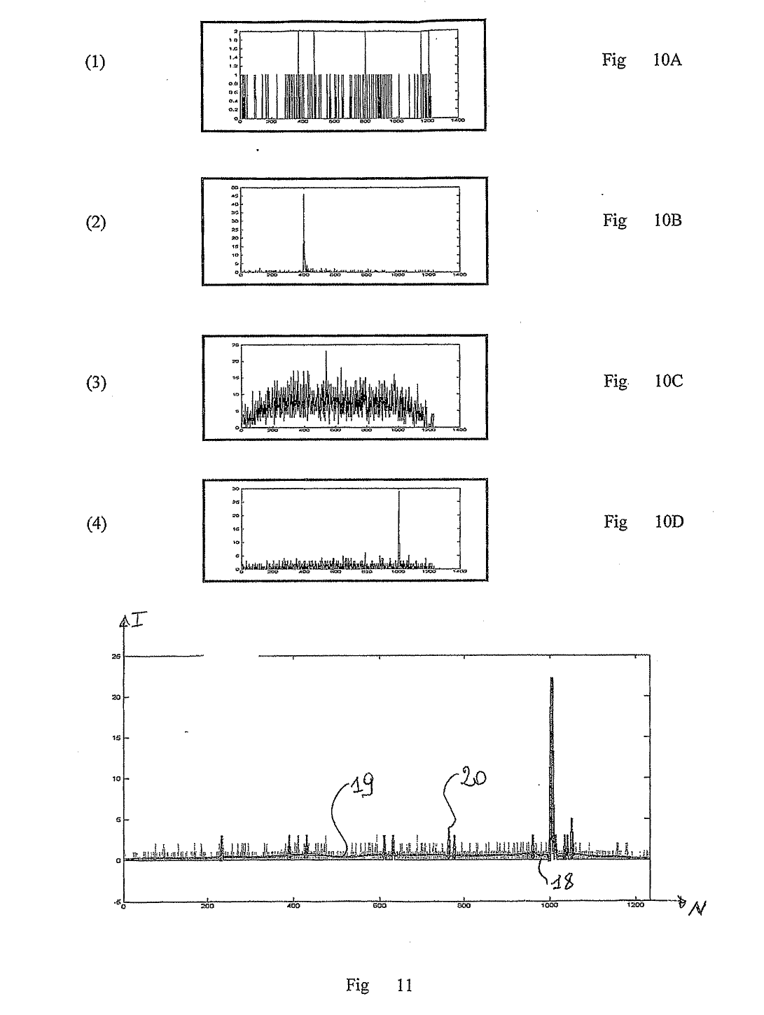

FIGS. 10A, . . . , 10D are possible diagrams of elution traces at a specific mass value (or SIC) of the matrix of FIG. 6B;

FIG. 11 is a diagram representing the implementation of the method of the present invention when applied to a single elution trace for a specific mass value (or SIC) of the matrix of FIG. 6B;

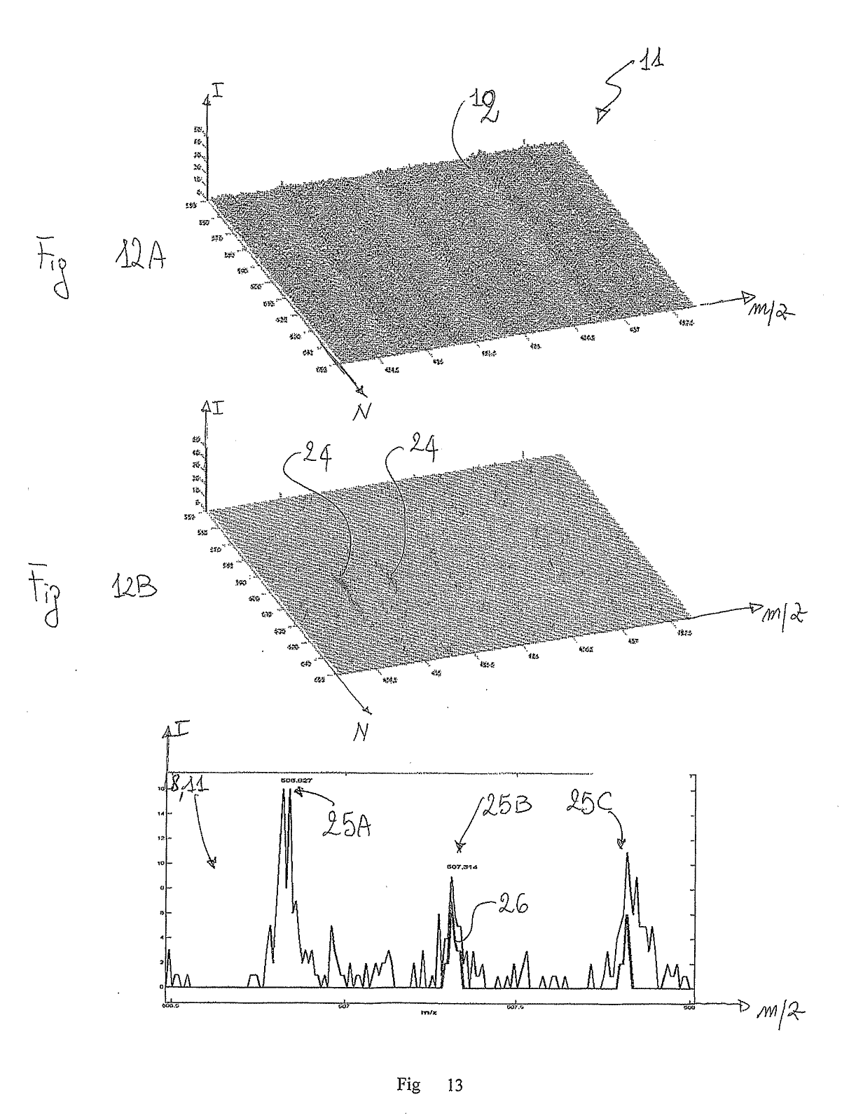

FIGS. 12A and 12B are diagrams that represent measurement signals without the implementation of the method of the present invention and with the implementation of the method of the present invention respectively;

FIG. 13 is diagram that shows false positive detection thanks to the application of the method of the present invention.

As described above, conventional approaches for removing noise peaks 12 overlapping the peptide peaks 9 in the measurement signal 8 (see FIG. 2) are based on the analysis of a single scan generated by the mass spectrometer 3.

Nonetheless, this causes the loss of an important part of the information, i.e. the chromatographic peptide separation dimension obtained by the chromatograph 2 contained in the acquisition and filtering chain 1 (see FIG. 1).

For best utilization of the information that can be retrieved from the chromatographic separation dimension, also referring to FIG. 3, a step is advantageously provided for reconstruction of the measurement signals obtained from the N scans performed by the acquisition and filtering chain 1.

Particularly, such reconstruction requires all the N successive scans to be arranged in adjacent positions to form a 3D map 11, showing all the chromatograms of an experiment:

In other words, in order to prevent any loss in the data generated by the acquisition and filtering chain 1, all the N scans are arranged in adjacent positions to form the 3D map 11.

Particularly, referring to FIG. 3, such 3D map 11 or measurement signal 11 has:
an axis that indicates the N scans (or, in an equivalent manner, the peptide elution times in the chromatograph 2, considering that the input of the spectrometer 3 is the elution signal of the chromatograph 2, which is sampled, for instance, every 2 seconds, and thus generate a mass scan every two seconds),
an axis that indicates the intensity value I of peptide peaks 9 and
an axis that indicates the mass-over-charge ratio of the ion.

It shall be noted that the intensity I of peptide peaks 9 in one scan is a function of both the mass value and the elution time in the liquid column of the chromatograph 2.

Nevertheless, once again in the representation of FIG. 3 the 3D map 11, i.e. the measurement signal 11, does not show whether a peak value 9 is actually a peptide peak or inherent noise 12 (including background noise, chemical and/or stochastic noise in each scan) of the measurement instruments that form the retrieval and filtering chain.

In prior art techniques, noise can be found in such 3D map 11 during a step in which an average spectrum is determined from multiple successive scans.

This step provides a highly regular pattern of equally spaced peaks 1 Th, as shown in FIG. 4A.

Such regular pattern can be confirmed by a transform operation, i.e. by applying a Fourier transform to the spectrum of FIG. 4A.

Particularly, further referring to FIG. 4B, the power spectrum is shown to include components at 1 Th⁻¹ and at the harmonics 2 Th⁻¹, 3 Th⁻¹, etc.

Considering that peptide peak values are not evenly distributed, these components can only represent noise 12, more particularly chemical noise 12a, also known as background b(t).

Nevertheless, the easily recognizable pattern in FIG. 4B is difficult to filter out by conventional methods.

Furthermore, prior art methods generate unacceptable artifacts in peptide signal reconstruction.

Such artifacts are most likely caused by the non-linearity of common filters, and by the changing morphology of peaks as mass changes, which is typical for spectra in which Time of Flight of ions is detected.

It should be noted that the spectrometer 3 of the acquisition and filtering chain 1 detects the Times of Flight (TOF) of peptides in the instruments and uses such values to determine their masses.

Particularly, there is a quadratic relation between times and masses, as shown below:

$${t}^{2} = \frac{m}{z} [ \frac{{d}^{2}}{2 {V}_{s} e} ]$$

where:

t=time of flight of the ion;

m=mass of the ion;

z=charge of the ion;

e=charge of an electron;

d=actual length of the TOF analyzer;

Vs=acceleration voltage in the TOF analyzer.

The above formula clearly shows that the mass m to charge z ratio of the ion is proportional to the squared Time of Flight TOF, that is:

$$\frac{m}{z} ∝ {t}^{2}$$

This quadratic relation involves wider peaks at high masses.

Nonetheless, when the 3D maps 11 as described above with reference to FIG. 3 are considered in addition to the individual mass spectra as shown in FIG. 2, it can be seen that peptide peaks 9 can be morphologically distinguished from chemical noise 12a along the chromatographic elution dimension.

Thus, as shown in FIG. 5, concerning a step in which, as mentioned above, an average spectrum has been determined from multiple successive scans in accordance with what was obtained for a single scan in FIG. 4A, chemical noise 12a is found to be constant throughout the N scans, whereas the peptide peak 9 looks like a Gaussian curve throughout the N scans.

Obviously, the peptide peaks 9 that can be seen from FIG. 5 belong to very high concentration peptides and cause no detection problem, even using prior art detection methods.

However, the purpose of the present invention is to allow detection of those peptide peaks that have such a low concentration as to be totally hidden below the elution profiles of chemical noise 12a.

Therefore, the 3D map 11 is a measurement signal generated by the combination of the chromatograph 2 and the mass spectrometer 3, which has at least one peak value 24 (see FIG. 12B) representative of a peptide peak whose concentration is so low as to be totally hidden below the elution profiles of noise 12, particularly chemical noise 12a.

Nonetheless, the detection of such peptide peaks 24 hidden below the elution profiles of chemical noise 12a is hindered by the problem that elution traces cannot be immediately retrieved from the data provided by the mass spectrometer 3, and have to be reconstructed off line.

Therefore, to allow evaluation of elution traces, the individual spectra obtained from the N scans of the mass spectrometer 3 (FIG. 6A) have to be reorganized to allow artificial reconstruction of chromatographic elution traces for each mass value of the spectra.

Particularly, such reorganization consists in creating a matrix M_{N×P} 14, in which the lines represent the N successive scans (i.e. specific elution times) and the P columns represent the intensity value of the i^{th} scan at the j^{th} clock tick (corresponding to a specific mass value).

The intensity value of each vector P depends on what is detected by the spectrometer 3 at a given time and at a given mass and can be either zero or related to noise, to the presence of a peptide or to the sum of the noise and the peptide signal.

This matrix is created through the following steps:
retrieving the data of the individual measurement signals 8 using the acquisition and filtering chain 1;
converting mass values into their equivalent time domain values TOF (where they become evenly spaced), considering that the Time of Flight is proportional to the square root of the mass over charge ratio of the ion, that is:

$$T ∝ \sqrt{\frac{m}{z}}$$

extrapolating the missing values in the time domain TOF, because the acquisition and filtering chain 1 does not record zero values, to obtain the same total number of abscissa values for each scan (number of clock ticks);
creating ClockTicks-TOF and ClockTicksm/z conversion tables;
creating the matrix M_{N×P} 14 with all the experiment data, where:

N=total number of scans;

P=total number of clock ticks;

i=scan number;

j=clock tick;

m_{i,j}=intensity value in the scan i and at the clock tick j, where 1<i<N and 1<j<P;

m_{ī,j}=row vector, corresponding to the mass spectrum, where 1<i<N and 1<j<P ;

m_{i, j̅}=column vector, representative of all elution values at a specific mass value of said j^{th} measurement signal (at a constant clock tick), where 1<i<N and 1<j<p.

Therefore, the matrix M_{N×P} 14 contains all the intensity values retrieved by the acquisition and filtering chain 1 throughout the N scans.

It shall be noted that the diagram of the column vector m_{i, j̅}, representative of all elution values at a specific mass value of the measurement signal at the j^{th} clock tick, is identified as a SIC (Single Ion Chromatogram), whose dimension is equal to the number N of scans performed by the acquisition and filtering chain 1.

Once the matrix 14 has been obtained, also with reference to FIG. 7, the method of the invention can be applied to each j^{th} column vector m_{i, j̅} or SIC.

Particularly, for each j^{th} column vector of intensity values m_{i, j̅} or SIC, the method includes the steps of:
performing a wavelet decomposition 15 of said j^{th} vector SIC to generate a first processed vector 16 representative of the smoothed intensity values of said column vector m_{i, j̅};
performing a wavelet decomposition 17 to generate the second processed vector 18 representative of the SIC signal cleaned of any oscillations generated by stochastic noise 12b;
setting a threshold value S;
processing said first processed vector 16 and said second processed vector 18, the latter accounting for said threshold value S, to generate a third processed vector 19 identifying the baseline value of said intensity column vector SIC;
processing said j^{th} vector SIC, said second 18 and said third 19 vectors, to generate a filtered vector 20 identifying a zᵢ value of the peptide peak 24 below the noise 12, if any.

In a preferred embodiment, the wavelet decompositions 15 and 17 may coincide in a single wavelet decomposition step.

The wavelet decomposition is assumed herein to be known to those of ordinary skill in the art, and will not be described in greater detail below.

It should be noted that the step of performing a wavelet decomposition 15 for said j^{th} vector SIC to generate a first processed vector 16 representative of the smoothed intensity values of the column vector m_{i, j̅} consists of a smoothing step.

Particularly, the first processed vector 16 is a vector with a dimension N, where N is the number of scans (or positions), in which each point of such processed value approximates the baseline of the specific SIC under examination.

More particularly, the wavelet decomposition 15 allows an estimate of the low frequency component of the measurement signal for the specific SIC under examination at the high scales of the decomposition approximations (FIG. 8A) and an estimate of the stochastic noise, i.e. the high frequency component, at the low scales of the decomposition details (FIG. 8B).

For this purpose, also referring to FIGS. 8A and 8B, the wavelet transform application step 15 has to be carried out while accounting for the most appropriate approximation and hence detail scale for the specific SIC being examined.

The selection of the approximation level shall be related to the relationship between scale, frequency and amplitude of peptide signals within the RT domain of each SIC of the matrix 14.

It should be particularly noted that the scale level can be related to the frequency, and hence to the amplitude of signals in the time domain.

It shall be noted that too high an approximation level (e.g. A8, A9, not shown in FIG. 8A) would cause oversmoothing and too low an approximation level, e.g. A3, A4 would cause detection of typical components of peptide peaks.

In a preferred embodiment of the present method, the preset approximation level ranges from the fifth A5 to the seventh A7 approximation levels.

Preferably, the sixth approximation level A6 (see FIG. 8A) was found to be the approximation level that best represents the baseline of the measurement signal 11 for the specific SIC under examination, while always using as a detail level the detail level cD1 (see FIG. 8B), which represents most of the stochastic noise 12b in the SIC.

In other words, the sixth approximation level A6 best approximates the carrier of the SIC.

Concerning the step of providing a threshold value S to perform the wavelet decomposition 17 and thus generate the second processed vector 18, such step consists, for instance, in using the wavelet decomposition 15 not only for smoothing the j^{th} SIC, but also for denoising it.

As an alternative, to generate the second processed vector 18, representative of the SIC signal cleaned of any oscillations caused by stochastic noise, the step of providing the threshold value S comprises the additional steps of:
determining whether the variance σ² of stochastic noise in one or more portions of the values of said intensity column vector SIC assumes different values in different time intervals, and
providing an additional threshold value Ŝ for each portion of the values of said intensity column vector SIC to determine the peptide peaks 24 that might remain below the threshold when using the threshold value S only.

Particularly, this additional step consists in determining whether the variance σ² of the background noise 12 of the values of the intensity column vector SIC changes throughout the period of the measurement signal.

If this is the case, the values of the intensity column vector SIC will be divided in as many intervals o portions as there are changes in the variance σ².

Furthermore, a measurement threshold g other than the threshold value S is assigned to each of these intervals or portions of values of the intensity column vector SIC.

Advantageously, the step of providing such additional threshold values S of each portion of values of said intensity column vector SIC in which the stochastic noise 12b has a non-stationary variance σ² allows detection of any peptide peaks 24 (in the respective portions of the intensity column vector SIC) that would remain below the threshold if a single threshold value S were used.

A dynamic programming algorithm, known to those of ordinary skilled in the art and not described any further, may be used for determining the times of change of the variance σ².

Particularly, with K being the maximum number of Change Points (i.e. the times of change of the variance σ² of stochastic noise 12b in the values of the intensity column vector SIC) and D being the minimum distance between two Change Points, and assuming that K and D are much smaller than the time length of the values of the intensity column vector SIC, this dynamic programming algorithm provides the above mentioned times of change of the variance σ² in the values of the intensity column vector SIC.

It shall be noted that the second processed vector 18 is also a vector having a dimension N, with N being the number of scans.

Particularly, the step of denoising the specific j^{th} SIC is based on a so-called thresholding process, which is preferably implemented as hard thresholding, but may also be implemented as soft thresholding.

More particularly, in this thresholding process, for each detail D1, D2, D3, etc. (see FIG. 8B) of the wavelet decomposition 15 (or similarly 17), all the coefficients whose absolute value is below the threshold S (or similarly Ŝ) are set to zero.

Then, the signal is anti-transformed with the new detail coefficients to generate the second processed vector 18 representative of the SIC signal cleaned of any oscillations generated by stochastic noise 12b.

It shall be noted that the thresholding process requires the threshold S (or any additional threshold values Ŝ that are set for each portion of values of the intensity column vector SIC) to be set for each detail of the decomposition, such threshold value S being calculated as a multiple of the standard deviation a of stochastic noise 12b.

As mentioned above, stochastic noise 12b is concentrated in the first detail level cD₁ of the wavelet decomposition, wherefore the problem can be associated to the calculation of the standard deviation σ of cD₁.

Such standard deviation a can be estimated by an estimator such as a MAD (Median Absolute Deviation), which is robust to the presence of outliers.

It should be further noted that MAD may be also used for estimating the variance σ² of the possible ?time intervals of the intensity column vector SIC.

It shall be noted that, in this specific case, the signal of interest is the baseline, and the outliers are peptide signals, if any, whose possible presence in cD₁ would be detected in few coefficients.

It shall be further noted that the MAD allows the heteroscedasticity of noise to be automatically accounted for.

In other words, during the wavelet transformation step 17 the heteroscedasticity of stochastic noise 12b shall be accounted for and its deviation a shall be determined.

Coefficients of the first detail of the wavelet decomposition CD1, which describe the high-frequency content of the signal and whose standard deviation can be estimated by means of the MAD estimator, are used for this purpose.

It should be noted that the graphical representation of a specific j^{th} vector SIC of the matrix 14, as shown in FIG. 9 can show two situations, as described below:
lack of chemical noise 12a, see portion 21 of the diagram: in this case, the diagram of FIG. 9 only shows stochastic noise (typically inherent with the instrument) and any peptide peak would be detected as a Gaussian peak extending through a few successive scans;
presence of chemical noise 12a, see portion 22 of the diagram: in this case, the diagram shows a baseline, i.e. an additional contribution throughout the N scans. This baseline may distort the intensity I of a peptide peak and even conceal it in certain cases, therefore it has to be eliminated.

The j^{th} column vector m_{i, j̅} or SIC of the matrix 14 can be thus completely identified with the following mathematical model:

f(t)=s(t)+e(t)+[b(t)+k_{b}e(t)]

where f(t) is the j^{th} SIC under examination, s(t) identifies the peptide signal 8, b(t) identifies chemical noise 12a (or the baseline), e(t) identifies stochastic noise 12b, typically white noise and k_{b} identifies a multiplicative constant, proportional to chemical noise b(t), that can account for the heteroscedasticity of stochastic noise 12b, whose variance a increases with chemical noise 12a, i.e. with the baseline.

Thus, the following four cases may be observed, also with reference to FIGS. 10A to 10D, that can define the type of j^{th} column vector m_{i, j̅} or SIC:
(1) f₁(t)=e(t), i.e. the j^{th} column vector m_{i, j̅} or SIC is only stochastic noise 12b (FIG. 10A);
(2) f₂(t)=e(t)+s(t), i.e. the j^{th} column vector m_{i, j̅} or SIC is the combination of stochastic noise 12b and peptide signal 8 (FIG. 10B);
(3) f₃(t)=e(t)+[b(t)+k_{b}*e(t)], i.e. the j^{th} column vector m_{i, j̅} or SIC is the combination of stochastic noise 12b and chemical noise 12a (i.e. baseline) (FIG. 10C);
(4) f₄(t)=e(t)+[b(t)+k_{b}*e(t)]+s(t), i.e. the j^{th} column vector m_{i, j̅} or SIC is the combination of stochastic noise 12b, chemical noise 12a (i.e. baseline) and peptide signal 8 (FIG. 10D).

Once the j^{th} column vector m_{i, j̅} or SIC has been deduced and mathematically characterized, a threshold value S to be used for denoising can be estimated through the value of the MAD.

As mentioned above, the threshold value S (or any additional threshold values Ŝ that that are set for each portion of values of the intensity column vector SIC) is a multiple of standard deviation a.

Thus, if the MAD is zero, then the j^{th} column vector m_{i, j̅} or SIC under examination will fall in the cases (1) and/or (2) (see FIGS. 10A and 10B respectively) of the above model, i.e. lack of chemical noise 12a (i.e. baseline).

In this case, stochastic noise 12b may be considered to be equal to a Gaussian white noise N(0,1) with zero mean and standard deviation o equal to one.

However, if the MAD is other than zero, the j^{th} column vector m_{i, j̅} or SIC under examination will fall in the cases (3) and (4) (see FIGS. 10C and 10D respectively) of the above model.

In the latter case, we find a chemical noise “hump” and stochastic noise may be considered to be equal to a Gaussian white noise that can be identified, for instance, by a normal standard distribution N(0, σ) with zero means and deviation σ calculated as follows

$$σ = \frac{MAD ( c {D}_{1} )}{0.6745}$$

where 0.6745 is the 75° percentile of normal standard deviation.

Therefore the threshold S (or any additional threshold values Ŝ that are set for each portion of values of the intensity column vector SIC) required for thresholding in the wavelet decomposition step 17 is a multiple of the standard deviation a of stochastic noise, that is:

S=(n σ)

where n is a multiplicative factor.

Once the j^{th} column vector m_{i, j̅} or SIC has been analyzed to obtain the vector 16 by the wavelet decomposition 15 and the vector 18 by the wavelet decomposition in 17 by a thresholding process, and once these two vectors 16 and 18 have been processed to generate the vector 19 representative of the approximation of chemical noise 12a (i.e. the baseline value) of the chromatographic signal, it shall be understood that this step of processing the two vectors 16 and 18 includes the following steps:
comparing said first processed vector 16 and said second processed vector 18 to generate a sixth processed vector 19A which identifies a position xᵢ, if any, in which said first 16 and second 18 processed vectors differ;
interpolating said first 16 or second processed vector 18 in said position xᵢ, if any, of said sixth processed vector 19A when a value other than zero is present in said position xᵢ to generate said third processed vector 19.

Particularly, the above comparison step substantially consists in generating the sixth processed vector 19A which identifies a possible intensity value xᵢ, with i ranging from 1<i<N. This intensity value xᵢ identifies the point in which the first processed vector 16 and the second processed vector 18 differ.

It shall be noted that the first processed vector 16 and the second processed vector 18 may differ in certain points only, wherefore the difference vector is composed of zero values, excepting the points in which said first processed vector 16 and said second processed vector 18 differ.

In other words, the baseline of the specific SIC under examination is estimated by retrieving the information shared by the two processed vectors 16 and 17, and next performing an interpolation step 19B at the points xᵢ, if any, in which the two vectors 16 and 18 differ.

For instance, the interpolation step 19B may be preferably carried out using the Piecewise Cubic Hermite Interpolating Polynomial PCHIP, or the spline function.

As described above, the filtered vector 20 is generated in a step in which the j^{th} intensity vector SIC and said second 18 and third 19 vectors are processed.

Particularly, the above comparison step includes the additional steps of:
comparing said second processed vector 18 with said third processed vector 19 to generate a fifth processed vector 23 representative of the positions yᵢ in which said possible peptide peak is present;
assigning a value Δᵢ to each of said positions yᵢ of said fifth processed vector 23, which value Δᵢ corresponds to the result of the comparison between said j^{th} intensity vector SIC and said third processed vector 19, so as to determine in said fourth filtered vector 20 the position and intensity of said peak value below said background noise for each scan along a SIC.

In other words, the filtered vector 20 can be obtained through the following steps:
Setting the values zᵢ of the filtered vector 20 to zero in all N positions;
Extracting the points yᵢ in which the i^{th} values of said second processed vector 18 minus the i^{th} values of said third processed vector 19 are positive to obtain the points yᵢ of the fifth processed vector 23, assumedly containing peptide peaks (i.e. (Denoised−Baseline)>0);
In these points yᵢ of the fifth processed vector 23, setting the values zᵢ of the filtered vector 20 to the value Δᵢ representative of the difference between the i^{th} value of the intensity vector SIC and the i^{th} value of said third processed vector 19 (i.e. SIC-baseline).

The final result of the implementation of the above method is shown in FIG. 11, in which the filtered vector 20 is shown to be obtained from the second processed vector 18 by means of the third processed vector 19.

Once each column vector m_{i, j̅} of the matrix 14 has been processed according to the above method, a matrix is obtained which is composed of P filtered vectors 20, each representing the presence of peptide peak values 24 below the threshold of background noise 12, chemical noise 12a and/or stochastic noise 12b for each scan N.

In other words, by the application of the method to all P vectors of the matrix 14, the matrix is wholly cleaned and can provide the P filtered elution traces SIC and allow reconstruction of the N filtered mass scans.

Thus, the acquisition and filtering chain 1 can create spectrographic files in most common formats such as “.txt”, “mzData”, “mzXML”, etc., such files being readable by a personal computer.

FIGS. 12A and 12B show the effectiveness of the above method in removing chemical noise 12a thereby highlighting the peptide peaks 24 that were wholly concealed in traditional techniques.

Advantageously, the inventive method is also useful for detection, as it avoids false positives.

Most of detection algorithms are based on the recognition of the isotopic distribution of a peptide, wherefore a peptide peak is recognized as such only when the peaks of its isotopes are also identified, at a distance that is compatible with the ionization charge of the peptide.

As shown in FIG. 13, the original signal 25 prior to cleaning by the inventive method has an isotopic distribution with three peaks with 0.5 Th intervals (thus corresponding to a peptide ionized with a +2 charge), these peak values being designated in FIG. 13 by 25A, 25B and 25C.

Once the detection method has been implemented, the filtered signal 26 does not have the first peak 25A of the isotopic distribution, which has been recognized as chemical noise and filtered off.

Without the implementation of the detection method, the real peptide of mass 507.314, i.e. the peak 25B, would never have been detected, and a false peptide of mass 506.827 would have been detected instead.

The inventive method provides improvements in two orders of magnitude during detection of peptide peaks combined with the noise of the measurement signal.

Those skilled in the art will obviously appreciate that a number of changes and variants may be made to the arrangements as described hereinbefore to meet incidental and specific needs, without departure from the scope of the invention, as defined in the following claims.

1-14. (canceled)

15. A method for noise rejection and detection within the data of a measurement signal (11) generated by the combination of a chromatograph (2) and a mass spectrometer (3), said data identifying the intensity values of the proteins contained in a biological sample, said measurement signal (11) having at least one peak value (24) combined with stochastic and/or chemical noise (12a, 12b), said peak value (24) being representative of a peptide peak that can be found in said measurement signal (11), said method comprising the steps of:
providing a Single Ion Chromatogram (SIC) representative of the elution values at a specific mass value (m/z) of said measurement signal (11);
performing a first wavelet decomposition (15) of said values of said Single Ion Chromatogram (SIC) to generate a first processed vector (16) representative of the smoothed intensity values of the Single Ion Chromatogram (SIC);
performing a second wavelet decomposition (17) of said values of said Single Ion Chromatogram (SIC) to generate a second processed vector (18) representative of said Single Ion Chromatogram (SIC) cleaned of any oscillations generated by stochastic noise (12b);
setting a threshold value (5);
processing said first processed vector (16) and said second processed vector (18), the latter accounting for said threshold value (S), to generate a third processed vector (19) identifying the baseline value of said Single Ion Chromatogram (SIC) so as to reject the chemical noise. wherein it further comprises the step of processing said Single Ion Chromatogram (SIC) and said second (18) and third (19) vectors to generate a filtered vector (20) identifying a value (z,) of said peptide peak (24) below said stochastic and/or chemical noise (12a, 12b).

16. Method as claimed in claim 15, wherein said step of processing said single Ion Chromatogram (SIC) and said first (16), second (18) and third (19) vectors includes the additional steps of:
comparing said second processed vector (18) with said third processed vector (19) to generate said fifth processed vector (23) representative of the points (y,) in which said peptide peak value (24) is present;
assigning a value (Δᵢ) to said points (yᵢ) of said fifth processed vector (23), which value corresponds to the result of the comparison between said Single Ion Chromatogram (SIC) and said third vector (19) to determine the presence of said value (zᵢ) of said peptide peak value (24) below said stochastic and/or chemical (12, 12a)

17. A method as claimed in claim 16, wherein said comparison step and said assignment step include the additional steps of:
setting the values (zᵢ) of said filtered vector (20) to zero in all N positions;
extracting the points in which the i^{th} values of said second processed vector (18) minus the i^{th} values of said third processed vector (19) are positive to obtain the points (yᵢ) of said fifth processed vector (23), said fifth processed vector being representative of the points in which peptide peaks are assumed to be present;
in correspondence of said points (yᵢ) of said fifth processed vector (23), setting said values (zᵢ) of said filtered vector (20) to the value (Δᵢ) representative of the difference between the i^{th} value of said intensity Single Ion Chromatogram (SIC) and the i^{th} value of said third processed vector (19).

18. A method as claimed in claim 15, wherein said step of providing a threshold value (S) and performing a wavelet decomposition (17) according to the value of said threshold (S) includes the additional steps of
processing the detail coefficients (cD1, cD2, cD3, . . . ) disregarding those below the value of said threshold value (S),
anti-transforming, using the new coefficients for said Single Ion Chromatogram (SIC) to generate said second processed vector (18).

19. A method as claimed in claim 18, wherein said step of providing a threshold value (S) and performing a wavelet decomposition (17) according to the value of said threshold (S) includes the additional steps of:
determining whether the variance (σ²) of stochastic noise (12b) in said values of said Single Ion Chromatogram (SIC) assumes different values in different time intervals, and
providing an additional threshold value (Ŝ) for each of said one or more portions of the values of said Single Ion Chromatogram (SIC), said additional threshold value (Ŝ) being different from the threshold value (S).

20. A method as claimed in claim 15, wherein said step of processing said first processed vector (16) and said second processed vector (18) to generate said third processed vector (19) includes the additional steps of:
comparing the values of said first processed vector (16) and said second processed vector (18) to generate a sixth processed vector (19A) which identifies a position (xᵢ), if any, in which said first (16) and second (18) processed vectors differ;
interpolating the values of said first (16) or second (18) processed vector in said position (xᵢ), if any, of said sixth processed vector (19A) when a value other than zero is present in said at least one position to generate said third processed vector (19).

21. A method as claimed in claim 15, wherein said step of providing the Single Ion Chromatogram (SIC) representative of the elution values at a specific mass value (m/z) of said measurement signal (11) includes, for each of the N scans, the additional steps of:
retrieving the data representative of the mass values (m/z) of said measurement signal (8);
converting the mass values (m/z) into their equivalent equally spaced time domain values (TOF) according to the following relation:
$$T ∝ \sqrt{\frac{m}{z}}$$
extrapolating the missing values in the time domain (TOF), in order to obtain the same total number of abscissa values for each scan (number of clock ticks);
creating a matrix M_{N×P} (14) with the experiment data, where:
N=total number of scans;
P=total number of abscissa values (clock ticks);
i=scan number;
j=clock tick;
m_{i,j}=intensity value in the scan i and at the clock tick j, where 1<i<N and 1<j<P;
m_{ī,j}=row vector, corresponding to the i^{th} mass spectrum, where 1<i<N and 1<j<P;
m_{i, j̅}=column vector, representative of all elution values at a specific mass value of said j^{th} measurement signal (at a constant clock tick), where 1<i<N and 1<j<P.

22. A method as claimed in claim 21, wherein the steps as claimed in claim 1 are repeated as many times as the total number (P) of the Single Ion Chromatogram (SIC) that form said matrix.

23. A method as claimed in claim 15, wherein said Single Ion Chromatogram (SIC) that forms a column of the P columns of the matrix M_{N×P} (14) can be identified by the following mathematical model:
f(t)=s(t)+e(t)+[b(t)+k_{b}e(t)]
wherein f(t) is said Single Ion Chromatogram (SIC), s(t) identifies a peptide signal, b(t) identifies the baseline associated with chemical noise, e(t) identifies stochastic noise and k_{b} identifies a multiplicative constant, proportional to b(t).

24. A method as claimed in claim 15, wherein said step of performing a wavelet decomposition (15) on said Single Ion Chromatogram (SIC) to generate a first processed vector (16), said wavelet decomposition (15) is performed at an approximation level ranging from the fifth approximation level (A5) to the seventh approximation level (A7), preferably at the sixth approximation level (A6).

25. A method as claimed in claim 15, wherein said threshold value (S) is a multiple of the standard deviation (a) of the stochastic noise of said intensity column vector (SIC), said standard deviation (a) being:
σ=MAD(cD1)/0.6745
wherein
MAD is a robust estimator of standard deviation σ (Median Absolute Deviation) and
cD1 is the first detail level of said wavelet decomposition (15).

26. A method as claimed in claim 15, wherein a further step is provided for creating a filtered spectrographic file, said spectrographic file being generated in any format selected from the formats “.txt”, “mzData”, “mzXML”.

27. A computer tool for processing data representative of the intensity values of a measurement signal (11), said measurement signal (11) having at least one peak value (24) combined with a stochastic and/or chemical noise (12a, 12b), said computer tool being adapted to be directly loaded into memory of a computer device, comprising portions of program code susceptible of implementing the method when run on said computer device, said method being for noise rejection and detection within the data of a measurement signal (11) generated by the combination of a chromatograph (2) and a mass spectrometer (3), said data identifying the intensity values of the proteins contained in a biological sample, said measurement signal (11) having at least one peak value (24) combined with stochastic and/or chemical noise (12a, 12b), said peak value (24) being representative of a peptide peak that can be found in said measurement signal (11), said method comprising the steps of:
providing a Single Ion Chromatogram (SIC) representative of the elution values at a specific mass value (m/z) of said measurement signal (11);
performing a first wavelet decomposition (15) of said values of said Single Ion Chromatogram (SIC) to generate a first processed vector (16) representative of the smoothed intensity values of the Single Ion Chromatogram (SIC);
performing a second wavelet decomposition (17) of said values of said Single Ion Chromatogram (SIC) to generate a second processed vector (18) representative of said Single Ion Chromatogram (SIC) cleaned of any oscillations generated by stochastic noise (12b);
setting a threshold value (S);
processing said first processed vector (16) and said second processed vector (18), the latter accounting for said threshold value (S), to generate a third processed vector (19) identifying the baseline value of said Single Ion Chromatogram (SIC) so as to reject the chemical noise.
wherein it further comprises the step of processing said Single Ion Chromatogram (SIC) and said second (18) and third (19) vectors to generate a filtered vector (20) identifying a value (zᵢ) of said peptide peak (24) below said stochastic and/or chemical noise (12a, 12b).

28. A system for processing data representative of intensity values of a measurement signal (11), said measurement signal (11) having at least one peptide peak value (24) combined with a stochastic and/or chemical noise (12a, 12b), said system comprising:
a chromatograph (2) for separating the peptides obtained by enzymatic digestion of the proteins contained in a biological sample;
a mass spectrometer (3) for detecting spectrum data of said measurement signal (8, 11);
a computer device for processing the spectrum data of said measurement signal (8, 11), said computer device comprising at least one processor, one memory associated with said at least one processor, a monitor and a computer tool adapted to be loaded in said memory, said computer tool being able for processing data representative of the intensity values of a measurement signal (11), said measurement signal (11) having at least one peak value (24) combined with a stochastic and/or chemical noise (12a, 12b), said computer tool being adapted to be directly loaded into memory of a computer device, comprising portions of program code susceptible of implementing the method when run on said computer device, said method being for noise rejection and detection within the data of a measurement signal (11) generated by the combination of a chromatograph (2) and a mass spectrometer (3), said data identifying the intensity values of the proteins contained in a biological sample, said measurement signal (11) having at least one peak value (24) combined with stochastic and/or chemical noise (12a, 12b), said peak value (24) being representative of a peptide peak that can be found in said measurement signal (11), said method comprising the steps of:
providing a Single Ion Chromatogram (SIC) representative of the elution values at a specific mass value (m/z) of said measurement signal (11);
performing a first wavelet decomposition (15) of said values of said Single Ion Chromatogram (SIC) to generate a first processed vector (16) representative of the smoothed intensity values of the Single Ion Chromatogram (SIC);
performing a second wavelet decomposition (17) of said values of said Single Ion Chromatogram (SIC) to generate a second processed vector (18) representative of said Single Ion Chromatogram (SIC) cleaned of any oscillations generated by stochastic noise (12b);
setting a threshold value (S);
processing said first processed vector (16) and said second processed vector (18), the latter accounting for said threshold value (S), to generate a third processed vector (19) identifying the baseline value of said Single Ion Chromatogram (SIC) so as to reject the chemical noise.
wherein it further comprises the step of processing said Single Ion Chromatogram (SIC) and said second (18) and third (19) vectors to generate a filtered vector (20) identifying a value (zᵢ) of said peptide peak (24) below said stochastic and/or chemical noise (12a, 12b).
